(19) United States
(12) Patent Application Publication
(10) Pub. No.: US 2004/0000836 A1
(43) Pub. Date: Jan. 1, 2004

(54) Brush and electric rotary device having the same

(76) Inventors: Masashi Okubo, Chiisagata-gun (JP); Morinobu Endo, Suzaka-shi (JP)

Correspondence Address: BIRCH STEWART KOLASCH & BIRCH, PO BOX 747, FALLS CHURCH, VA, 22040-0747, US

(21) Appl. No.: 10/603,651

(22) Filed: Jun. 26, 2003

(30) Foreign Application Priority Data
Jun. 28, 2002 (JP) 2002-189706

(51) Int. Cl. H02K 13/00

(52) U.S. Cl. 310/252

(57) ABSTRACT

The brush is capable of reducing contact resistance between the brush and a commutator, improving efficiency of a motor and restricting exhaustion of the brush. The brush includes carbon nano fibers and/or carbon nano tubes whose outermost layers have electric conductivity.

### BACKGROUND OF THE INVENTION

The present invention relates to a brush and an electric rotary device, e.g., a motor, an electric generator, having the brush.

Conventional electric rotary devices, e.g., motors, electric generators, have graphite brushes, metal-graphite brushes, metallic brushes, etc..

The graphite brush is manufactured by the steps of: mixing graphite, which is a brush material, with a binder, e.g., pitch, plastic powders; molding the mixture with applying pressure; and baking the molded body.

The metal-graphite brush is manufactured by the steps of: mixing graphite, which is a brush material, with a binder, e.g., pitch, plastic powders, and metal powders, e.g., copper powders, silver powders, further molybdenum disulfide having solid lubricity if required; molding the mixture with applying pressure; and baking the molded body. Note that, if amount of metal powders is increased, the binder may be omitted.

The metal-graphite brush is shown in FIG. 7. A symbol 10 stands for the metal-graphite brush, and a symbol 12 stands for a commutator. In the brush 10, copper powders 14 and graphite powders 16 are mixed, and voids are formed therebetween.

The metallic brush is manufactured by fixing sliding members of a power feeding mechanism, which is made of a silver-palladium alloy, a gold-silver alloy, etc., to a spring member or stamping a clad material, which is made of adhering a spring member and a contact member.

Conventionally, the brush to be used is selected on the basis of current intensity of an electric current passing through the brush, contact-resistance between the brush and a commutator, environmental resistance to a sulfide gas atmosphere, etc.. However, a preferred brush cannot be selected without experiments or tests.

Brushes must be worn and abraded while using. Therefore, a span of life of a motor is defined by brush employed. A spans of life of an ordinary motor is 2,000-3,000 hours.

There are several types of exhaustion of a brush: adhesive wear, which is caused by adhering a brush to a commutator and peeling the adhered part; abrasive wear, which is caused by forming hard substances, e.g., oxides, on one or both of sliding faces of the brush and the commutator and grinding soft parts with the hard substances; arc wear, which is caused by metal transfer, evaporation, etc. occurred by melting metallic powders of sliding faces of the brush and the commutator by arc therebetween; and oxidization wear, which is caused by oxidizing carbides of graphite and binders of the brush when the slider sections are overheated.

However, the conventional metallic brush does not have enough sliding characteristics.

On the other hand, the conventional graphite brush and the conventional metal-graphite brush include graphite, so they have enough sliding characteristics.

However, graphite employed in the conventional brushes has a layered crystal structure. Electric conductivity in the direction along faces of crystal layers is highly greater than that in the direction perpendicular to the faces of the crystal layers. By the anisotropy, contact resistance between graphites and between graphite and metal highly vary according to contact directions therebetween. For example, in FIG. 7, an electric current having enough intensity flows in the direction along faces of the graphite 16; the current passes along an arrow. Therefore, efficient must be low. Further, many projected parts and voids exist in the brush 10, so area of contacting the commutator 12 must be small; the sliding characteristics of the brush 10 must be bad in spite of including graphite. By the bad sliding characteristics, the exhaustion of the brush is apt to be occurred, so that the span of life of the brush must be short. To use a motor for a long time, a long brush is used or a brush exchanging mechanism for periodically exchanging the brush is assembled. If the brush exchanging mechanism is assembled, a size of a motor must be larger, and an operator must exchange brush frequently.

### SUMMARY OF THE INVENTION

The present invention has been invented so as to solve the problems of the conventional brushes.

An object of the present invention is to provide a brush capable of reducing contact resistance between the brush and a commutator, improving efficiency of a motor and restricting exhaustion of the brush.

Another object of the present invention is to provide an electric rotary device having said brush.

To achieve the objects the present invention has following structures.

The brush of the present invention includes carbon fibers (carbon nano fibers and/or carbon nano tubes) whose outermost layers have good electric conductivity.

The brush may comprise a power feeding mechanism, e.g., a commutator, a slip ring, whose sliding section includes the carbon fibers.

In the brush, a abrasable layer may be formed on the sliding face side of the sliding section.

In the brush, the sliding section may be fixed to a plate- or rod-shaped spring member.

In the brush, the sliding section may include a metallic material and the carbon fibers so as to have electric conductivity.

In the brush, the sliding section may include graphite.

The electric rotary device, e.g., a motor, an electric generator, of the present comprises a brush including carbon nano fibers and/or carbon nano tubes whose outermost layers have electric conductivity.

By employing the brush of the present invention, the carbon fibers reduces the contact resistance between the brush and the commutator; the efficiency of the motor having the brush can be improved. Further, exhaustion of the brush can be restricted, so that a span of life of the brush can be longer.

### BRIEF DESCRIPTION OF THE DRAWINGS

Embodiments of the present invention will now be described by way of examples and with reference to the accompanying drawings, in which:

FIG. 1 is an explanation view of a brush of an embodiment of the present invention, wherein a first brush layer and a second brush layer are formed;

FIG. 2 is an explanation view of another brush, which has a third brush layer (an abrasable layer);

FIG. 3 is a perspective view of a leaf spring, to which the brush is attached;

FIG. 4 is a perspective view of another leaf spring, to which the brush is attached;

FIG. 5 is an explanation view of a leaf spring, in which an electric conductive film is formed by dispersal plating;

FIG. 6 is an explanation view showing a structure of the brush; and

FIG. 7 is an explanation view showing a structure of the conventional brush.

### DETAILED DESCRIPTION OF THE EMBODIMENTS

Preferred embodiments of the present invention will now be described in detail with reference to the accompanying drawings.

In the following embodiments, known carbon nano fibers and carbon nano tubes are employed as carbon fibers.

A sliding section of a brush, which slides on a commutator, includes carbon nano fibers or carbon nano tubes. One layer or a plurality of layers of the carbon fibers are used. One end or both ends of each layer may be closed by a fullerene-shaped cup or cups.

Note that, the carbon nano fiber means a carbon nano tube whose length is at least 1,000 times greater than a diameter.

Diameters of the carbon fibers used in the embodiments are several nanometers (nm) to several hundred nanometers (nm), e.g., 300 nm, at the largest.

If the diameter of the carbon fibers is less than 15 nm, electric conductivity is reduced. In the case of the carbon fibers whose diameter is less than 15 nm, if chiral indexes “n” and “m”, which defines chiral vector assigning a spiral direction of a crystal structure, satisfy following formulas F1 or F2, the carbon fibers have electric conductivity.

n−m=a multiple of 3 (F1)

n=m (F2)

On the other hand, in the case of the carbon fibers whose diameter is 15 nm or more, the carbon fibers always have electric conductivity.

In the present invention, the carbon fibers is mixed in a brush material. Unlike graphite, the carbon fibers have no anisotropy of electric conductivity. Namely, an electric current can pass surfaces of the carbon fibers in every direction. The carbon fibers mutually contact or contact other members. Therefore, at least outermost layers of the carbon fibers must have electric conductivity.

In the present embodiment, the carbon nano fibers or the carbon nano tubes are added to a material constituting of a conventional graphite brush or a conventional metal-graphite brush. The material is mixed with the carbon nano fibers or the carbon nano tubes. The mixture is molded with applying pressure. The carbon nano fibers or the carbon nano tubes are included in a sliding face of the molded body, which will slide on a commutator. Finally, the molded body is baked to complete the brush. Note that, steps of manufacturing the brush is not limited.

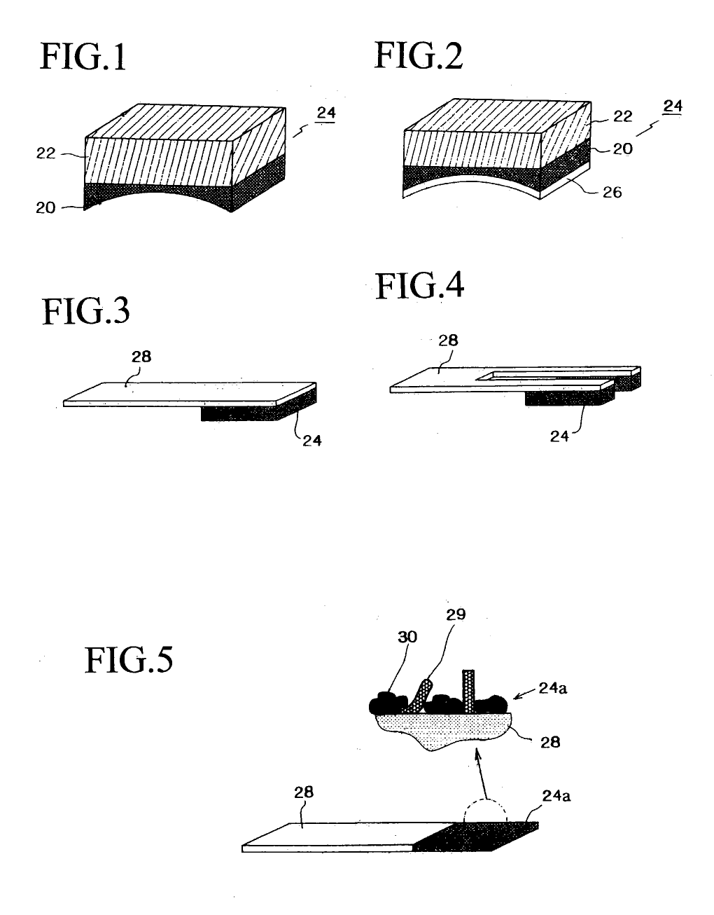

The brush of the present embodiment is shown in FIG. 1. The brush 24 is manufactured by the steps of: supplying a molding die, in which mixed powders including the carbon nano fibers or the carbon nano tubes are provided on the commutator side and in which mixed powders including no carbon nano fibers or carbon nano tubes are provided on the other side; molding the mixed powders with applying pressure; and baking the molded body. With these manufacturing steps, the brush 24 has a first brush layer 20 including the carbon nano fibers or the carbon nano tubes, and a second brush layer 22 including no carbon nano fibers or carbon nano tubes.

The carbon fibers are expensive. However, by forming two brush layers 20 and 22, manufacturing cost can be reduced.

The second brush layer 22 may be optionally employed, and it depends on, for example, the cost of the carbon fibers.

Materials constituting the brush 24 except the carbon nano fibers or the carbon nano tubes are graphite, metal powders, a binder (pitch or synthetic resin powders), an additive (solid lubricant), etc.. The metal powders, the binder and the additive may be optionally used, and amount of them may be adjusted on the basis of use. Namely, they are not limited.

Amount of the carbon nano fibers or the carbon nano tubes too may be adjusted on the basis of use.

In an embodiment shown in FIG. 2, a brush 24 has three brush layers. A first brush layer 20 including carbon nano fibers or carbon nano tubes is sandwiched between a second brush layer 22 and a third brush layer 26, which include no carbon nano fibers or carbon nano tubes. The brush 24 is manufactured by the steps of: supplying brush materials in a molding die; molding the materials with applying pressure; and baking the molded body.

At the beginning of using a motor, the brush 24 insecurely contacts a commutator due to positioning errors of the brush 24 and the commutator, vibration of the brush 24, etc.. To solve the problem, the brush 24 has the third brush layer 26. The third brush layer 26 is an abrasable layer, which can be easily abraded, so that the brush 24 can securely contacts the commutator after the abrasion.

In an embodiment shown in FIG. 3, a brush 24 includes carbon nano fibers or carbon nano tubes, and is fixed to a leaf spring 28.

The brush 24 shown in FIG. 3 may be manufactured by baking. Further, it may be manufactured by the steps of: mixing carbon nano fibers or carbon nano tubes with synthetic resin; and injection-molding with the mixed resin.

The brush 24 may be fixed to the leaf spring 28 by an electric conductive adhesive, a screw, caulking, etc..

A modified embodiment of the brush shown in FIG. 3 is shown in FIG. 4. A front end of a leaf spring 28 is formed into a U-shape. With this structure, a brush 24 can stably contact a commutator.

In an embodiment shown in FIG. 5, sliding sections of a leaf spring 28 and a commutator are plated with an electric conductive metal. The plating is dispersal plating, in which carbon nano fibers or carbon nano tubes are mixed with a plating solution, and a plating metal 30 enclosing the carbon nano fibers 29 or the carbon nano tubes 29 precipitates on the leaf spring 28. By the dispersal plating, a sliding film 24a including the carbon nano fibers or the carbon nano tubes is formed on the leaf spring 28.

As shown in a partial enlarged part of FIG. 5, parts of carbon fibers 29 are held and fixed by the plating metal 30.

The dispersal plating is one of means for fixing the carbon nano fibers 29 or the carbon nano tubes 29. In another case, carbon nano fibers or carbon nano tubes, which have been floated in a gas, may be fixed to a leaf spring by thermal spraying. Namely, fixing means is not limited.

The brush 24 of each embodiment can be employed as a brush of a know electric rotary device, e.g., motor, electric generator. Explanation of the known electric rotary device will be omitted.

The carbon fibers (the carbon nano fibers or the carbon nano tubes) round one layer of graphite crystal. Therefore, the carbon fibers have one dimensional electric conductivity. Contact resistance (electric resistance) between the carbon fibers, between the carbon fibers and the metal and between the carbon fibers and the graphite can be always stable.

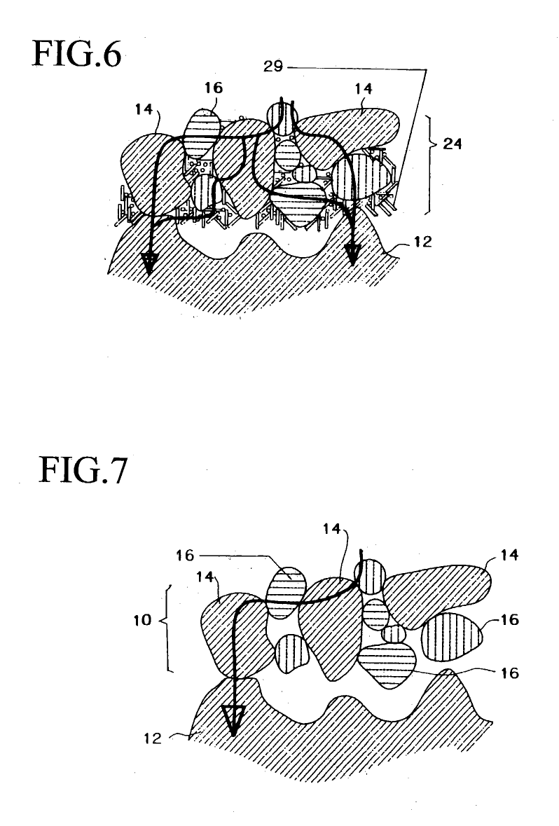

Unlike other materials constituting the brush, the carbon nano fibers or the carbon nano tubes are fine materials, so they can enter gaps between particles of other materials (see FIG. 6). The carbon fibers 29 (the carbon nano fibers or the carbon nano tubes) fill the gaps between the commutator 12, the copper powders 14 and the graphite 16.

By filling the gaps with the carbon fibers 29, concaves in a surface of the brush 24, which are caused by the gaps between the materials 14 and 16, are filled with the carbon fibers 29, so that roughness of a sliding face of the brush 24, which contacts the commutator, can be improved. Namely, a smooth sliding face can be formed.

A melting point of the carbon nano fibers or the carbon nano tubes is at least 2,000° C. higher than that of a metal used for contact points, e.g., copper. Conventionally, the metal used for contact points is often melted by arc, so that the melted metal is scattered or metal transfer is occurred. However, in the present invention, the abrasion caused by metal transfer, scattering metal, etc. can be reduced.

Further, the carbon nano fibers or the carbon nano tubes are highly chemically sable, so they can be used in a bad atmosphere, e.g., sulfide atmosphere.

Since the sliding face of the brush is smooth, frictional resistance between the brush and the commutator can be reduced. Further, a projection or projections formed by the metal transfer can be prevented, so that the abrasive wear can be reduced.

By improving the roughness of the sliding face of the brush, actual contact area between the brush and the commutator can be broader. Therefore, the resistance between the brush and the commutator can be reduced, and load and an electric current can be dispersed, so that heat generated in the contact parts can be reduced. By reducing the heat, the adhesive wear occurred between the sliding faces of the brush and the commutator can be reduced.

The carbon nano fibers or the carbon nano tubes have not only high electric conductivity but also high heat conductivity. Further, as described above, the fine carbon nano fibers or the fine carbon nano tubes fill the gaps between particles of the materials constituting the sliding faces of the brush and the commutator, so that the actual contact area between the brush and the commutator can be much broader. By the broad contact area, heat generated between the brush and the commutator can be dispersed in the brush, so that deterioration of the brush and the oxidization wear caused by overheating the sliding faces can be reduced. Therefore, disorganization of the sliding faces of the brush and the commutator can be prevented.

The carbon nano fibers and the carbon nano tubes have high tensile strength in the axial directions thereof, further they have enough flexibility. Even if the carbon nano fibers or the carbon nano tubes are projected from the sliding face of the brush which does not contact the commutator, they can be easily bent on the sliding face of the commutator by load, which is applied when the brush contacts the commutator. With this action, concentrating load to front ends of the carbon nano fibers or the carbon nano tubes can be prevented. Further, side faces of the carbon nano fibers or the carbon nano tubes contact the commutator instead of the front ends thereof, the actual contact area between the brush and the commutator can be broader. Note that, in the conventional motor, front ends of projected materials constituting a brush contact a commutator, so their actual contact area is small, and load constitutes to the front ends thereof.

In the brush of the present invention, in case expensive carbon nano fibers or carbon nano tubes are provided to the sliding face only, total amount of them can be reduced. Namely, manufacturing cost of the brush can be reduced, and a span of life of the brush can be made longer.

In the above described embodiments, the carbon nano fibers or the carbon nano tubes are included in the brush. But, they may be include in a sliding member of the commutator, contact points of relays or switches, etc.

The invention may be embodied in other specific forms without departing from the spirit or essential characteristics thereof. The present embodiments are therefore to be considered in all respects as illustrative and not restrictive, the scope of the invention being indicated by the appended claims rather than by he foregoing description and all changes which come within the meaning and range of equivalency of the claims are therefore intended to be embraced therein.

What is claimed is:

1. A brush including carbon nano fibers whose outermost layers have electric conductivity.

2. The brush according to claim 1,
comprising a power feeding mechanism, whose sliding section includes the carbon nano fibers.

3. The brush according to claim 2,
wherein an abrasable layer is formed on the sliding face side of said sliding section.

4. The brush according to claim 2,
wherein said sliding section is fixed to a spring member.

5. The brush according to claim 4,
wherein said sliding section includes a metallic material and the carbon nano fibers so as to have electric conductivity.

6. The brush according to claims 2,
wherein said sliding section includes graphite.

7. A brush including carbon nano tubes whose outermost layers have electric conductivity.

8. The brush according to claim 7,
comprising a power feeding mechanism, whose sliding section includes the carbon nano tubes.

9. The brush according to claim 8,
wherein a abrasable layer is formed on the sliding face side of said sliding section.

10. The brush according to claim 8,
wherein said sliding section is fixed to a spring member.

11. The brush according to claim 10,
wherein said sliding section includes a metallic material and the carbon nano tubes so as to have electric conductivity.

12. The brush according to claims 8,
wherein said sliding section includes graphite.

13. An electric rotary device,
comprising a brush including carbon nano fibers whose outermost layers have electric conductivity.

14. An electric rotary device,
comprising a brush including carbon nano tubes whose outermost layers have electric conductivity.
